(19) United States
(12) Patent Application Publication
(10) Pub. No.: US 2022/0230206 A1
(43) Pub. Date: Jul. 21, 2022

(54) RISK BASED ASSIGNMENT OF PROPERTY VALUATIONS IN FINANCIAL LENDING SYSTEMS

(71) Applicant: Wells Fargo Bank, N.A., San Francisco, CA (US)

(72) Inventors: Zhiyao Xiao, Charlotte, NC (US); Michael Munley, Charlotte, NC (US); Rebecca Howell, Charlotte, NC (US); Maura Rutemiller, Harrisburg, NC (US); David Nole, San Francisco, CA (US)

(21) Appl. No.: 15/291,908

(22) Filed: Oct. 12, 2016

(51) Int. Cl. G06Q 30/02; G06Q 10/06; G06Q 40/02

(52) U.S. Cl. CPC G06Q 30/0278; G06Q 50/16; G06Q 40/025; G06Q 10/063112

(57) ABSTRACT

Techniques are described for computing a risk based assignment (RBA) score for a valuation of a target property, and assigning an appraiser to perform the valuation based on the RBA score. The techniques may be used to select appraisers for mortgage loan default or origination. The RBA score is a numerical value used to estimate a level of complexity of the valuation of the target property in a given time. The level of complexity of the valuation is gauged by valuation accuracy, which is influenced by a level of difficulty to select comparable properties. The disclosed techniques comprise a model configured to assess the complexity of the valuation based on property specific information for the target property and generated neighborhood property information associated with a neighborhood of the target property. The techniques ensure that high complexity valuations are assigned to appraisers and valuation tools identified as being highly accurate.

### TECHNICAL FIELD

The disclosure relates to property valuations in financial lending systems.

### BACKGROUND

Financial lending institutions may originate loans as well as manage loan repayment and loan default. The loan products offered by the financial lending institutions may include mortgage loans for homes or other real property, auto loans, student loans, and other real or personal property loans. In the case of either loan origination or loan default for a mortgage loan, a financial lending institution may select an appraiser to perform a valuation of a target property. As one example, for a mortgage loan origination, the financial lending institution may select an appraiser that performs interior valuations, because the target property is more likely to be empty or inhabited by cooperative sellers. As another example, for a mortgage loan default, the lending institution may select an appraiser that performs exterior valuations, because the target property is more likely to be inhabited by the defaulting borrowers, who may not want to cooperate in the foreclosure process.

### SUMMARY

In general, this disclosure describes techniques for computing a risk based assignment (RBA) score for a valuation of a target property, and assigning an appraiser to perform the valuation based on the RBA score. The disclosed techniques may be used to select appraisers for either mortgage loan default or mortgage loan origination. The disclosed techniques may be used to select appraisers for property valuations that use sales comparison methods, such as valuations of residential property. The RBA score is a numerical value used to estimate a level of complexity of the valuation of the target property in a given time. The level of complexity of the valuation of the target property is gauged by valuation accuracy, which is influenced by a level of difficulty to select comparable properties. The disclosed techniques comprise a model or algorithm configured to assess the complexity of the valuation based on property specific information for the target property and generated neighborhood property information for surrounding properties within a same neighborhood as the target property. The techniques ensure that high complexity valuations are assigned to appraisers and valuation tools identified as being highly accurate.

According to the disclosed techniques, the RBA score is computed based on factors that make comparable properties difficult to select for the target property. For example, these factors include data availability in a geographic region of the target property, similarity of the target property to surrounding properties, and volatility of the local real estate market. The disclosed techniques may compute an accurate RBA score by performing comparisons between the target property and surrounding properties at a detailed geographic level, e.g., zip code level, zip-plus-two code level, or zip-plus-four code level as opposed to a metropolitan statistical area (MSA) level, a county level, or a state level. In addition, the disclosed techniques may compute an accurate RBA score by determining data availability at a county level as opposed to a state level, and/or placing more weight on market conditions in the case of a stable market.

In one example, this disclosure is directed to a method comprising receiving, by a computing device, property specific information of a target property for which a valuation has been ordered; receiving, by the computing device, property market information associated with a geographic region in which the target property is located; generating, by the computing device and from the property market information, neighborhood property information for surrounding properties within a same neighborhood as the target property; computing, by the computing device, a RBA score for the target property based on comparisons of the property specific information of the target property to the neighborhood property information for the surrounding properties within the same neighborhood as the target property, wherein the RBA score indicates a level of complexity of the valuation of the target property; and based on the RBA score, assigning, by the computing device, an appraiser to perform the valuation of the target property.

In another example, this disclosure is directed to a computing device comprising one or more storage units, and one or more processors in communication with the one or more storage units. The one or more processors are configured to receive property specific information of a target property for which a valuation has been ordered; receive property market information associated with a geographic region in which the target property is located; generate, from the property market information, neighborhood property information for surrounding properties within a same neighborhood as the target property; compute a RBA score for the target property based on comparisons of the property specific information of the target property to the neighborhood property information for the surrounding properties within the same neighborhood as the target property, wherein the RBA score indicates a level of complexity of the valuation of the target property; and based on the RBA score, assign an appraiser to perform the valuation of the target property.

In a further example, this disclosure is directed to a non-transitory computer-readable medium comprising instructions that when executed cause one or more processors to receive property specific information of a target property for which a valuation has been ordered; receive property market information associated with a geographic region in which the target property is located; generate, from the property market information, neighborhood property information for surrounding properties within a same neighborhood as the target property; compute a risk based assignment (RBA) score for the target property based on comparisons of the property specific information of the target property to the neighborhood property information for the surrounding properties within the same neighborhood as the target property, wherein the RBA score indicates a level of complexity of the valuation of the target property; and based on the RBA score, assign an appraiser to perform the valuation of the target property.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram illustrating an example property valuation system that includes a computing device configured to compute a risk based assignment (RBA) score to estimate a level of complexity of a valuation of a target property in a given time, in accordance with the techniques of this disclosure.

FIG. 2 is a block diagram illustrating an example computing device including a RBA unit configured to compute a RBA score for a target property in a given time, in accordance with the techniques of this disclosure.

FIG. 3 is a conceptual diagram illustrating one example of a model used to compute a RBA score for a target property in a given time as a weighted sum of a property risk score, a price risk score, and a market risk score.

FIG. 4 is a conceptual diagram illustrating one example of a model used to compute the property risk score included in the RBA score model from FIG. 3.

FIG. 5 is a conceptual diagram illustrating one example of a model used to compute a property characteristic risk level included in the property risk score model from FIG. 4.

FIG. 6 is a conceptual diagram illustrating one example of a model used to compute the price risk score included in the RBA score model from FIG. 3.

FIG. 7 is a conceptual diagram illustrating one example of a model used to compute the market risk score included in the RBA score model from FIG. 3.

FIG. 8 is a flowchart illustrating an example operation of a computing device configured to compute a RBA score for a target property in a given time, and assign an appraiser to the target property based on the RBA score, in accordance with the techniques of this disclosure.

### DETAILED DESCRIPTION

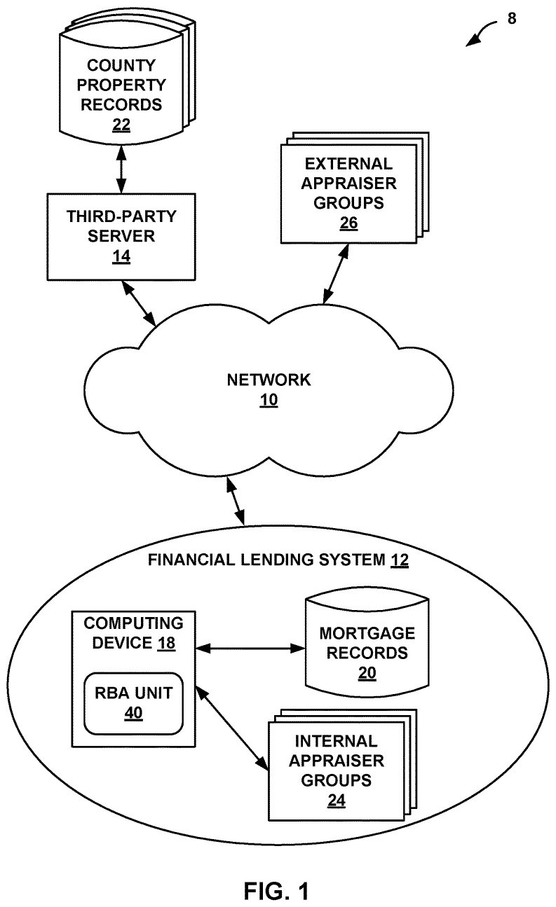

FIG. 1 is a block diagram illustrating an example property valuation system that includes a computing device configured to compute a risk based assignment (RBA) score to estimate a level of complexity of a valuation of a target property in a given time, in accordance with the techniques of this disclosure.

In the illustrated example of FIG. 1, property valuation system 8 includes a financial lending system 12 that may be associated with a financial institution, e.g., a federally insured bank, a credit unit, or a nonbank lender, offering loan products to its customers. The loan products offered by the financial institution may include mortgage loans for homes or other real property, auto loans, student loans, and other real or personal property loans. Financial lending system 12 may originate loans as well as manage loan repayment and loan default. As part of either a loan origination or a loan default for a mortgage loan, financial lending system 12 may select an appraiser to perform a valuation of a target property.

In general, a valuation of a target property is based, at least in part, on comparisons to similar properties in nearby geographic regions to the target property. As such, property valuations vary in complexity according to a level of difficulty to select comparable properties, which influences valuation accuracy. For example, properties for which few comparable properties can be identified tend to have a higher risk of being inaccurately valued. As described in more detail below, factors used to assess the degree of difficulty to select comparable properties for a target property may include data availability in a geographic region of the target property, similarity of the target property to surrounding properties, and volatility of the local real estate market.

The techniques of this disclosure include a model or algorithm to compute a RBA score as a numerical value used to estimate a level of complexity of a valuation of a target property in a given time. The disclosed model is configured to assess the complexity of the valuation based on property specific information for the target property and generated neighborhood property information for surrounding properties within a neighborhood as the target property. The disclosed model may be configured to compute the RBA score for the target property in a given time, such as a given month, a given quarter, or a given year. The time constraint may be applied to the RBA score because property market information changes over time, and data availability in a geographic region of the target property may also change over time.

The techniques of this disclosure further include a model or algorithm to automatically assign the valuation of the target property to an appropriate appraiser based on the RBA score. The disclosed techniques may be used to select appraisers for either mortgage loan default or mortgage loan origination. The disclosed techniques may be used to select appraisers for valuations of residential property and other types of property valuations that use a sales comparison method. In some examples, complexity of valuations that use an income method or build cost analysis may not be measurable using the RBA score computation techniques described in this disclosure. In some cases, financial lending system 12 may categorize appraisers, and valuation tools used by the appraisers, based on their accuracy. The disclosed techniques ensure that high complexity valuations are assigned to appraisers and valuation tools identified as being highly accurate.

As shown in FIG. 1, financial lending system 12 includes a computing device 18 configured to execute a RBA unit 40 to compute RBA scores for valuations of target properties, in accordance with the techniques of this disclosure. Financial lending system 12 may be part of a centralized or distributed system of one or more computing devices, including computing device 18. The one or more computing devices of financial lending system 12 may include desktop computers, laptops, workstations, wireless devices, network-ready appliances, file servers, print servers, or other devices. In some examples, financial lending system 12 may be hosted by an associated financial institution, and perform loan origination and management processes for the financial institution. In other examples, financial lending system 12 may be hosted by a third-party vendor of an associated financial institution, and perform RBA score computation and appraiser selection for valuations ordered by the financial institution.

In the illustrated example of FIG. 1, financial lending system 12 includes mortgage records 20 that include records of the mortgages originated and/or managed by financial lending system 12. In other cases, financial lending system 12 may not store mortgage records 20, but computing device 18 may access the mortgage records 20 from an external database or other storage system of the associated financial institution. Mortgage records 20 may include property specific information, such as property type, location, lot size, year built, square footage, bedroom and bathroom count, and estimated and assessed property values, for each of a plurality of mortgaged properties, including the target property.

As illustrated in FIG. 1, financial lending system 12 may access county property records 22 via a third-party server 14 over a network 10. In some examples, network 10 may comprise a private telecommunications network associated with a financial institution or a third-party vendor that is hosting financial lending system 12. In other examples, network 10 may comprise a public telecommunications network, such as the Internet. Although illustrated as a single entity, network 10 may comprise any combination of public and/or private telecommunications networks, and any combination of computer or data networks and wired or wireless telephone networks. In some examples, network 10 may comprise one or more of a wide area network (WAN) (e.g., the Internet), a virtual private network (VPN), a local area network (LAN), a wireless local area network (WLAN) (e.g., a Wi-Fi network), a wireless personal area network (WPAN) (e.g., a Bluetooth® network), or the public switched telephone network (PSTN).

County property records 22 may include property market information associated with a given county, such as distressed and total sale counts in the local real estate market of the county, sales price and assessed values in the local real estate market of the county, and typical property characteristics of properties located in the county. In some examples, third-party server 14 may comprise a government agency server, e.g., a county government server, configured to provide financial lending system 12 with access to county property records 22. In other examples, third-party server 14 may comprise a vendor server configured to gather county property records 22 from county governments in at least one region of the country, and provide the property market information to financial lending system 12.

In order to compute a RBA score for a valuation ordered by financial lending system 12 for a target property, computing device 18 receives property specific information for the target property from mortgage records 20, receives property market information associated with a geographic region of the target property from a third-party server 14. For example, the received property market information may comprise property-level information for each property with the geographic region, e.g., the county, of the target property. In other examples, the geographic region may be a state or a metropolitan statistical area (MSA) in which the target property is located. In still other examples, the received property market information may comprise neighborhood-level information for properties with the geographic region.

In accordance with the disclosed techniques, computing device 18 uses the received property market information to generate neighborhood property information for surrounding properties within a neighborhood in which the target property is located. The generated neighborhood property information for the surrounding properties is defined at a neighborhood-level (e.g., at one of a zip code level, a zip-plus-two code level, or a zip-plus-four code level). In one example, upon receiving the property-level property market information, computing device 18 may identify the surrounding properties that are included in a same neighborhood as the target property, and generate, from the property market information, the neighborhood property information for the surrounding properties within the same neighborhood as the target property.

Computing device 18 then executes RBA unit 40 to compute the RBA score for the target property based on comparisons of the property specific information of the target property to the neighborhood property market information for surrounding properties. According to the disclosed techniques, RBA unit 40 computes the RBA score based on factors that make comparable properties difficult to select for the target property. For example, these factors include data availability in a geographic region of the target property, similarity of the target property to surrounding properties, and volatility of the local real estate market.

In accordance with the disclosed techniques, RBA unit 40 may compute an accurate RBA score by performing comparisons between the target property and the surrounding properties at a detailed geographic level within a same neighborhood as opposed to a same MSA, a same county, or a same state. The “same neighborhood” of the target property and the surrounding properties may be defined by one of a same zip code, a same zip-plus-two code, or a same zip-plus-four code. In general, ZIP (Zone Improvement Plan) codes correspond to address groups or delivery routes that may be derived geographically. For example, a basic five-digit ZIP code may be associated with an area of a city in a metropolitan area or a village or town outside of a metropolitan area. The expanded ZIP code system uses the basic five-digit code plus additional digits to identify a geographic segment at a more detailed level within the five-digit delivery area. For example, a zip-plus-two code may include the basic five-digit code plus two additional digits to identify a group of city blocks or an area of a village or town. As another example, a zip-plus-four code may include the basic five-digit code plus four additional digits to identify a single city block, a group of apartments, or an individual high-volume receiver of mail.

For example, RBA unit 40 may be configured to identify the surrounding properties that are included in a same zip-plus-two code as the target property. RBA unit 40 may be configured to analyze the property market information received from third-party server 14 to compute a set of median property characteristics of the surrounding properties within the same zip-plus-two code as the target property. In addition, RBA unit 40 may be configured to analyze the property market information received from third-party server 14 to compute an average assessed value of the surrounding properties within the same zip-plus-two code as the target property. In some examples, RBA unit 40 may also be configured to analyze the property market information received from third-party server 14 to compute sales data for a local real estate market within the same zip code as the target property. By determining zip level market information and performing the comparisons with the surrounding properties at the zip-plus-two level, as opposed to the MSA level, county level, or state level, RBA unit 40 generates a more accurate view of comparable properties and, thus, computes a more accurate RBA score for the target property.

In further accordance with the disclosed techniques, RBA unit 40 may compute a more accurate RBA score by determining data availability at a county level as opposed to a state level. For example, RBA unit 40 may be configured to analyze the property market information received from third-party server 14 to determine availability of property market data within a county of the target property. By determining county-level data availability, RBA unit generates a more accurate view of data availability and, thus, computes a more accurate RBA score for the target property. In addition, RBA unit 40 may compute an accurate RBA score by placing more weight or emphasis on market conditions in the case of a stable, and therefore more predictable, local real estate market.

Based on the RBA score, RBA unit 40 assigns an appraiser to perform the valuation of the target property. In the example of FIG. 1, RBA unit 40 may select the appraiser for the property valuation from one of internal appraiser groups 24 or external appraiser groups 26. Financial lending system 12 may categorize appraisers, and valuation tools, based on their accuracy ratings in performing property valuations. For example, financial lending system 12 may rank appraisers included in their own internal appraiser groups 24 as more accurate than appraisers included in external appraiser groups 26. Internal appraiser groups 24 include staff appraisers of the financial institution associated with financial lending system 12, and are considered to be the most accurate appraisers. External appraiser groups 26 may include proprietary fee panel (PFP) appraisers that may be former staff appraisers and/or trained by staff appraisers, and are considered to be the most accurate external appraisers. External appraiser groups 26 may also include fee appraisers that are individual appraisers having a one-on-one relationship with the financial institution, and are considered to be the next most accurate external appraisers. External appraiser groups 26 may further include appraisal management companies (AMCs) that are national providers of appraisals and considered to be the least accurate appraisers.

RBA unit 40 may select the appraiser from one of internal appraiser groups 24 or external appraiser groups 26 based on the RBA score and the appraiser's accuracy rating. In this way, RBA unit 40 may be configured to assign high complexity valuations, e.g., those with high RBA scores, to appraisers and valuation tools identified as being highly accurate. In addition, RBA unit 40 may be configured to assign low complexity valuations, e.g., those with low RBA scores, to appraisers and valuation tools with lower accuracy ratings in order to reduce the work load on the highly accurate appraisers.

The architecture of property valuation system 8 and financial lending system 12 illustrated in FIG. 1 is shown for exemplary purposes only and should not be limited to this architecture. Property valuation system 8 illustrated in FIG. 1 includes a single third-party server 14 connected to financial lending system 12 via network 12. In other examples, property valuation system 8 may include a plurality of third-party servers each having access to one or more property records, which may be city-level, county-level, state-level, or the like. Financial lending system 12 illustrated in FIG. 1 includes a single computing device 18 coupled to mortgage records 20. In other examples, financial lending system 12 may include multiple different computing devices configured to execute RBA units to perform the valuation complexity determination operations described above with respect to computing device 18 for properties included in mortgage database 20 or different mortgage or property databases or other storage systems.

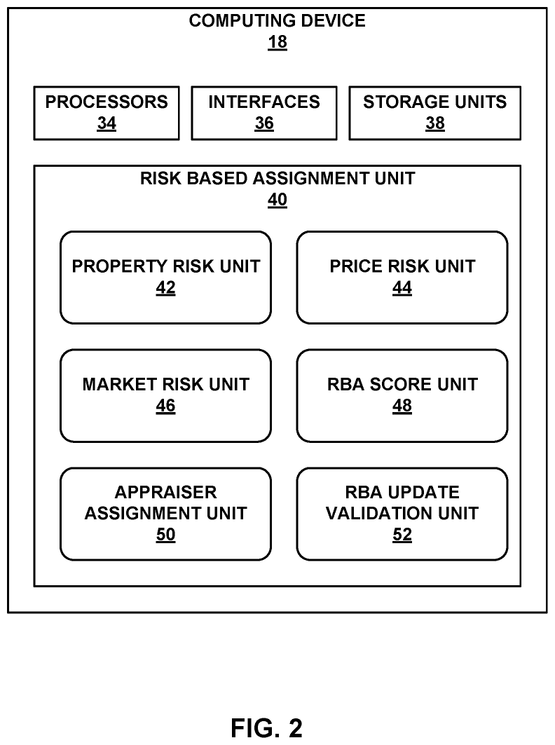

FIG. 2 is a block diagram illustrating an example computing device 18 including a risk based assignment (RBA) unit 40 configured to compute a RBA score for a target property in a given time, in accordance with the techniques of this disclosure. The architecture of computing device 18 illustrated in FIG. 2 is shown for exemplary purposes only and computing device 18 should not be limited to this architecture. In other examples, computing device 18 may be configured in a variety of ways.

As shown in the example of FIG. 2, computing device 18 includes one or more processors 34, one or more interfaces 36, and one or more storage units 38. Computing device 18 also includes RBA unit 40, which may be implemented as program instructions and/or data stored in storage units 38 and executable by processors 34 or implemented as one or more hardware units or devices of computing device 18. Storage units 38 of computing device 18 may also store an operating system and a user interface unit executable by processors 34. The operating system stored in storage units 38 may control the operation of components of computing device 18. Although not shown in FIG. 2, the components, units or modules of computing device 18 are coupled (physically, communicatively, and/or operatively) using communication channels for inter-component communications. In some examples, the communication channels may include a system bus, a network connection, an inter-process communication data structure, or any other method for communicating data.

Processors 34, in one example, may comprise one or more processors that are configured to implement functionality and/or process instructions for execution within computing device 18. For example, processors 34 may be capable of processing instructions stored by storage units 38. Processors 34 may include, for example, microprocessors, digital signal processors (DSPs), application specific integrated circuits (ASICs), field-programmable gate array (FPGAs), or equivalent discrete or integrated logic circuitry, or a combination of any of the foregoing devices or circuitry.

Storage units 38 may be configured to store information within computing device 18 during operation. Storage units 38 may include a computer-readable storage medium or computer-readable storage device. In some examples, storage units 38 include one or more of a short-term memory or a long-term memory. Storage units 38 may include, for example, random access memories (RAM), dynamic random access memories (DRAM), static random access memories (SRAM), magnetic discs, optical discs, flash memories, or forms of electrically programmable memories (EPROM) or electrically erasable and programmable memories (EEPROM). In some examples, storage units 38 are used to store program instructions for execution by processors 34. Storage units 38 may be used by software or applications running on computing device 18 (e.g., RBA unit 40) to temporarily store information during program execution.

Computing device 18 may utilize interfaces 36 to communicate with external devices via one or more networks. Interfaces 36 may be network interfaces, such as Ethernet interfaces, optical transceivers, radio frequency (RF) transceivers, or any other type of devices that can send and receive information. Other examples of such network interfaces may include Wi-Fi or Bluetooth radios. In some examples, computing device 18 utilizes interfaces 36 to communicate with external devices such as mortgage records 20 and internal appraiser groups 24 within financial lending system 12, and third-party server 14 and external appraiser groups 26 via network 10.

Computing device 18 may include additional components that, for clarity, are not shown in FIG. 2. For example, computing device 18 may include a battery to provide power to the components of computing device 18. As another example, computing device 18 may include input and output user interface (UI) devices to communicate with an administrator or another user of financial lending system 12. Similarly, the components of computing device 18 shown in FIG. 2 may not be necessary in every example of computing device 18.

In the example illustrated in FIG. 2, RBA unit 40 includes a property risk unit 42, a price risk unit 44, a market risk unit 46, a RBA score unit 48, an appraiser assignment unit 50, and a RBA update validation unit 52. According to the techniques of this disclosure, the components of RBA unit 40 of computing device 18 are configured to compute a RBA score for a valuation of a target property, and assign an appraiser to perform the valuation based on the RBA score. RBA unit 40 may be applied to property valuations ordered for either mortgage loan default or mortgage loan origination.

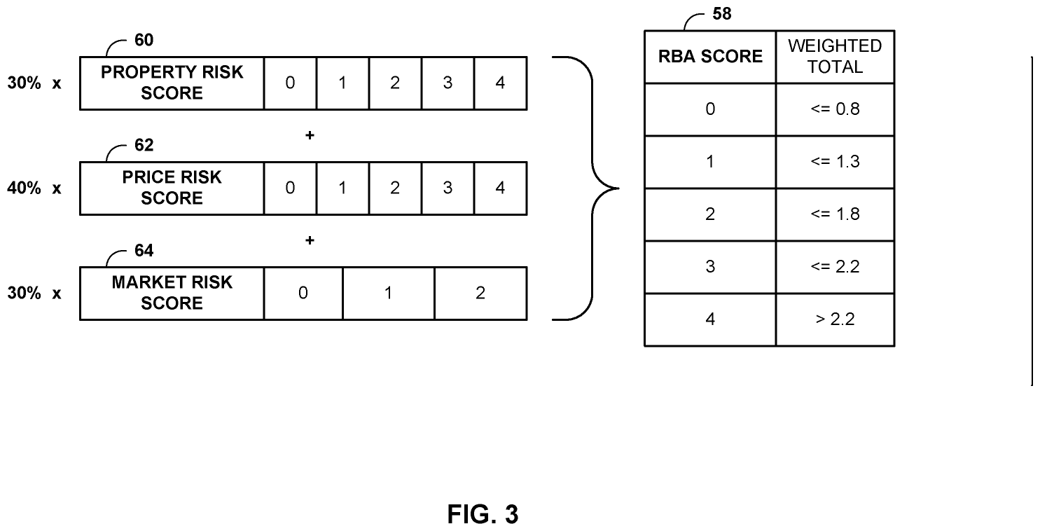

RBA score unit 48 may be configured to compute the RBA score for the valuation of the target property in a given time from the output of property risk unit 42, price risk unit 44, and market risk unit 46. Property risk unit 42, price risk unit 44, and market risk unit 46 are configured to assess a level of complexity of the valuation of the target property based on factors that make comparable properties difficult to select for the target property. Because the basis of the RBA score computation techniques is evaluating how difficult it is to select comparable properties, the techniques may only be applied to valuations of residential property and other types of property valuations that use a sales comparison method. In some examples, complexity of valuations that use an income method or build cost analysis may not be measurable using the RBA score computation techniques described in this disclosure. One example of a model or algorithm that may be executed by RBA score unit 48 to compute the RBA score is described in more detail below with respect to FIG. 3.

Property risk unit 42 may be configured to compute a property risk score based on data availability at a county-level and similarity of property characteristics between the target property and surrounding properties in a same neighborhood. In general, comparable properties are more difficult to select when the target property is located in a county with limited data availability, has a property type such as a condominium in certain specified area or multifamily, and does not conform to the surrounding properties in terms of lot size, bedroom and bathroom count, year built, and square footage.

Property risk unit 42 may receive property specific information of the target property from a database or other storage system, e.g., mortgage records 20 within financial lending system 12 from FIG. 1, via interfaces 36. The property specific information used to compute the property risk score may include property location, property type, lot size, year built, square footage, and bedroom and bathroom count for the target property. Property risk unit 42 may also receive property market information associated with a geographic region in which the target property is located from a third-party server, e.g., third-party server 14 coupled to county property records 22 from FIG. 1, via interfaces 36. The property market information used to compute the property risk score may include property characteristics of surrounding properties that are similar to those included in the property specific information received for the target property. Property risk unit 42 may receive the property specific information and/or the property market information in a given time period, such as a given month, a given quarter, or a given year.

According to the disclosed techniques, property risk unit 42 is configured to analyze the received property market information to determine availability of property market data associated with a county in which the target property is located. For example, property risk unit 42 may estimate data availability based on a success rate of a third-party Automatic Valuation Model (AVM). In some examples, an AVM may value every property included in a county with a confidence level. If the confidence level is too low, then it may be referred to as a “no hit.” If a given county has a large AVM no hit rate, then that county may have low data availability. There are several reasons for an AVM model to be unsuccessful when attempting to determine a value for a property, including that the property has an incorrect address; the property is a condominium with a common street address and unit numbers that are rarely reflected in public record data, which makes matching the address input problematic; and limitations on data available from public record and multiple listing service (MLS) resources. Property risk unit 42 may evaluate the success rates of multiple third-party AVMs for properties in the county in which the target property is located. By evaluating multiple third-party AVMs, the effects of incorrect address and condominiums are eliminated, and the impact of individual AVM limitations is reduced. Property risk unit 42 may, therefore, determine data availability in the county.

Property risk unit 42 is also configured to analyze the received property market information to determine typical property characteristics of surrounding properties within the same neighborhood as the target property. For example, property risk unit 42 may generate as set of median property characteristics of surrounding properties from property-level information (e.g., public records data on properties and county assessments) received from a third-party server, e.g., third-party server 14 coupled to county property records 22 from FIG. 1. More specifically, property risk unit 42 may identify surrounding properties that are included in the same neighborhood as the target property, and analyze the property-level information in order to generate the set of median property characteristics of the surrounding properties at the neighborhood-level, e.g., one of a zip code level, a zip-plus-two code level, or a zip-plus-four code level. Property risk unit 42 is further configured to compare the set of median property characteristics of the surrounding properties to the property specific information of the target property.

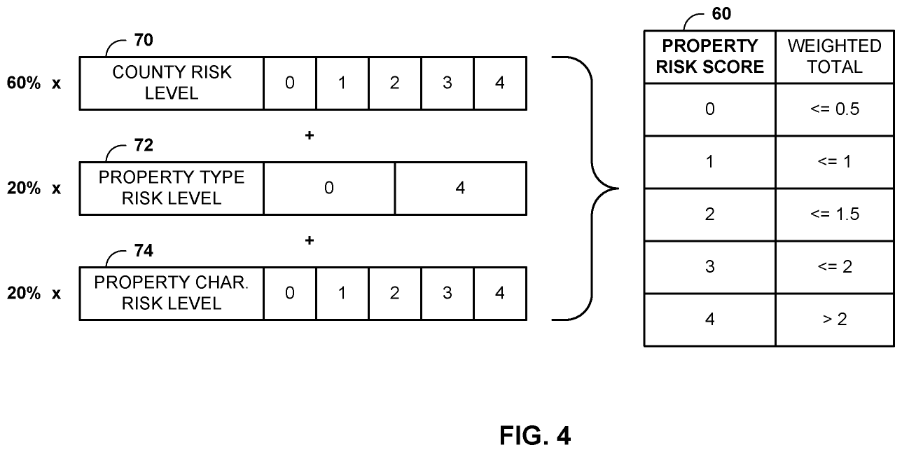

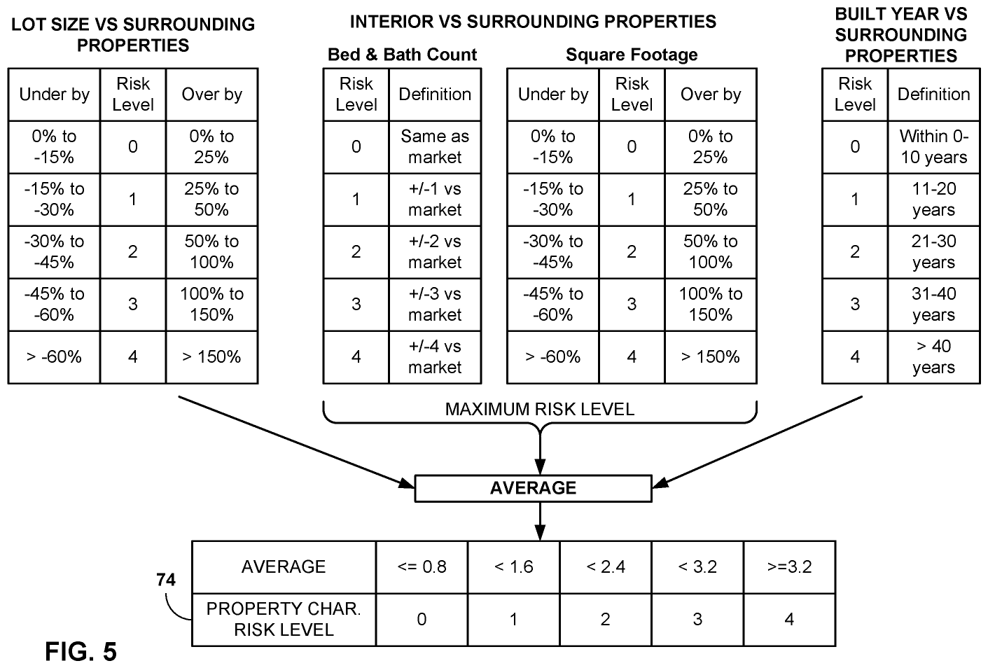

By determining county-level data availability, as opposed to a state-level, property risk unit 42 generates a more granular and, therefore, more accurate view of data availability. In addition, by generating neighborhood-level property characteristics of the surrounding properties and performing the comparisons with the surrounding properties at the neighborhood level, as opposed to the MSA level, the county level, or the state level, property risk unit 42 generates a more granular and, therefore, more accurate view of comparable properties. In this way, property risk unit 42 is able to compute an accurate property risk score, which will be used by RBA score unit 48 to compute the RBA score for the target property. Examples of the models or algorithms that may be executed by property risk unit 42 to compute the property risk score are described in more detail below with respect to FIGS. 4 and 5.

Price risk unit 44 may be configured to compute a price risk score based on similarity of property values between the target property and surrounding properties in a same neighborhood. In general, comparable properties are more difficult to select when the target property's value is different than the market value of the surrounding properties.

Price risk unit 44 may receive property specific information of the target property from a database or other storage system, e.g., mortgage records 20 within financial lending system 12 from FIG. 1, via interfaces 36. The property specific information used to compute the price risk score may include an estimated current property value and an assessed property value for the target property. Price risk unit 44 may also receive property market information associated with a geographic region in which the target property is located from a third-party server, e.g., third-party server 14 coupled to county property records 22 from FIG. 1, via interfaces 36. The property market information used to compute the price risk score may include sales prices and assessed values of properties in the local real estate market of the geographic region. Price risk unit 44 may receive the property specific information and/or the property market information in a given time period, such as a given month, a given quarter, or a given year.

According to the disclosed techniques, price risk unit 44 is configured to analyze the received property market information to determine market values of surrounding properties within a same neighborhood as the target property. For example, price risk unit 44 may generate an average assessed value of surrounding properties from property-level information received from a third-party server, e.g., third-party server 14 coupled to county property records 22 from FIG. 1. More specifically, price risk unit 44 may identify surrounding properties that are included in the same neighborhood as the target property, and analyze the property-level information in order to generate the average assessed value of the surrounding properties at a neighborhood level, e.g., one of a zip code level, a zip-plus-two code level, or a zip-plus-four code level. As another example, price risk unit 44 may determine the median sales price of the surrounding properties at the neighborhood level directly from a third-party server, e.g., third-party server 14 coupled to county property records 22 from FIG. 1. Price risk unit 44 is further configured to compare the determined market values of the surrounding properties to the property value of the target property.

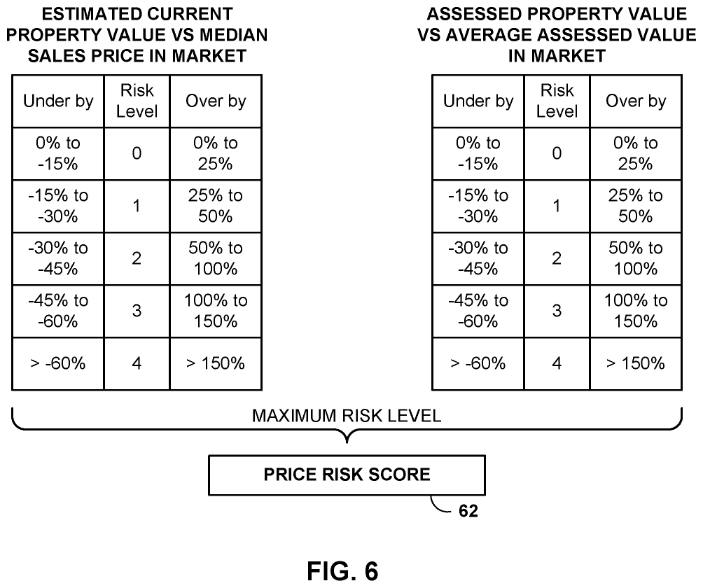

By determining neighborhood-level market values of the surrounding properties and performing the comparisons with the surrounding properties at the neighborhood level, as opposed to the MSA level, the county level, or the state level, price risk unit 44 generates a more granular and, therefore, more accurate view of comparable properties. In this way, price risk unit 44 is able to compute an accurate price risk score, which will be used by RBA score unit 48 to compute the RBA score for the target property. One example of a model or algorithm that may be executed by price risk unit 44 to compute the price risk score is described in more detail below with respect to FIG. 6.

Market risk unit 46 may be configured to compute a market risk score based on volatility of the local real estate market in the neighborhood of the target property. In general, comparable properties are more difficult to select when the market is in a state of transition in terms of distressed sales or when overall sales are low.

Market risk unit 46 may receive property market information associated with a geographic region in which the target property is located from a third-party server, e.g., third-party server 14 coupled to county property records 22 from FIG. 1, via interfaces 36. The property market information used to compute the market risk score may include distressed sales in the local real estate market of the geographic region and a total sales count in the local real estate market of the geographic region. Market risk unit 46 may receive the property market information in a given time period, such as a given month, a given quarter, or a given year.

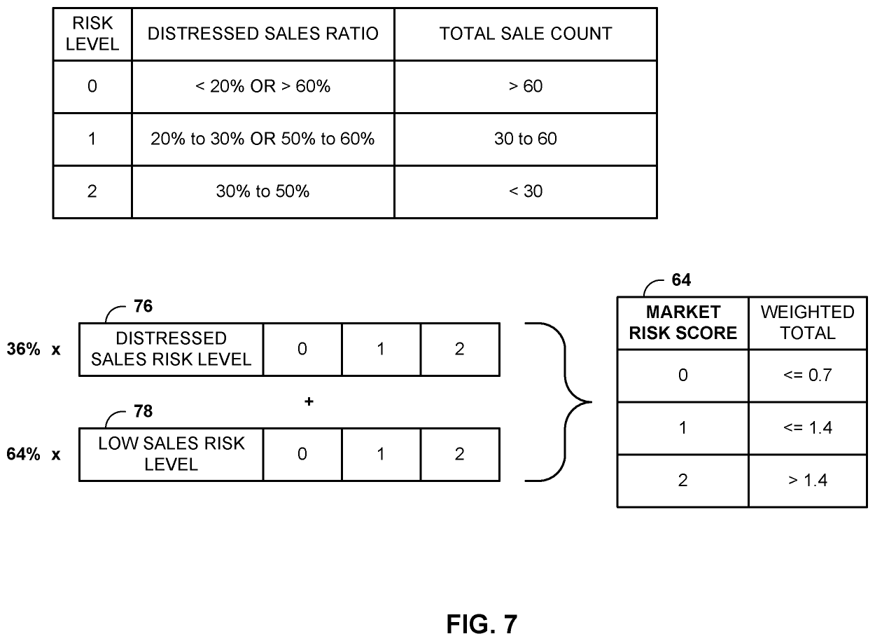

According to the disclosed techniques, market risk unit 46 is configured to analyze the received property market information to determine the market conditions in the local real estate market of the surrounding properties within the same neighborhood as the target property. For example, market risk unit 46 may determine the distressed sales for the local real estate market at a neighborhood level, e.g., one of a zip code level, a zip-plus-two code level, or a zip-plus-four code level, directly from a third-party server, e.g., third-party server 14 coupled to county property records 22 from FIG. 1. As another example, market risk unit 46 may determine the total sales count for the local real estate market at the neighborhood level directly from a third-party server, e.g., third-party server 14 coupled to county property records 22 from FIG. 1. By determining neighborhood-level sales data, as opposed to the MSA level, the county level, or the state level, market risk unit 46 generates a more granular and, therefore, more accurate view of the local real estate market. In this way, market risk unit 46 is able to compute an accurate market risk score, which will be used by RBA score unit 48 to compute the RBA score for the target property. One example of a model or algorithm that may be executed by market risk unit 46 to compute the market risk score is described in more detail below with respect to FIG. 7.

RBA score unit 48 may receive the property risk score from property risk unit 42, the price risk score from price risk unit 44, and the market risk score from market risk unit 46. In one example, RBA score unit 48 computes the RBA score as a weighted sum of the property risk score, the price risk score, and the market risk score. RBA score unit 48 may compute an accurate RBA score based on the property risk score, price risk score, and market risk score being computed at the neighborhood level. In addition, RBA score unit 48 may compute an accurate RBA score by placing more weight or emphasis on the market risk score in the case of a stable, and therefore more predictable, local real estate market.

RBA score unit 48 computes the RBA score for the target property as a numerical value that indicates a level of complexity of the valuation of the target property in a given time. For example, RBA score unit 48 may be configured to compute the RBA score for the target property in a given time, such as a given month, a given quarter, or a given year, based on the time period of the property specific information and/or the property market information used to compute the property risk score, the price risk score, and the market risk score. The time constraint may be applied to the RBA score because the data availability, the property specific information, and/or the property market information may change over time.

In one example, RBA score unit 48 outputs a RBA score ranging from 0 to 5. In this example, a RBA score equal to 5 indicates that the target property has a high value. A RBA score equal to one of 0 through 4 assess the complexity of the valuation based on property and market characteristics of the target property. In this example, the higher the value of the RBA score, the higher the level of complexity of the valuation of the target property.

Appraiser assignment unit 50 of RBA unit 40 is configured to assign an appraiser to perform the valuation based on the RBA score and an accuracy rating associated with the appraiser. For example, appraiser assignment unit 50 may select the appraiser for the property valuation from one of internal appraiser groups 24, considered to be the most accurate appraisers, or external appraiser groups 26, considered to be less accurate than the internal staff appraisers. In some examples, appraiser assignment unit 50 may select the appraiser and a certain valuation tool to be used by the appraiser based on the RBA score, the accuracy of both the appraiser and the valuation tool, and the type of valuation to be performed. For example, the different valuation tools may include a desktop appraisal, an in-person evaluation, an interior appraisal, or an exterior appraisal. Once the appraiser is selected, appraiser assignment unit 50 may assign the valuation of the target property to the selected appraiser via interfaces 36.

In accordance with the disclosed techniques, RBA score unit 48 may compute an accurate RBA score for the valuation of the target property, and appraiser assignment unit 50 may assign the most appropriate appraiser to the valuation of the target property. For example, appraiser assignment unit 50 may be configured to assign high complexity valuations, e.g., those with high RBA scores, to appraisers and valuation tools identified as being highly accurate. In addition, appraiser assignment unit 50 may be configured to assign low complexity valuations, e.g., those with low RBA scores, to appraisers and valuation tools with lower accuracy ratings in order to reduce the work load on the highly accurate appraisers.

As one example, in the case where RBA score unit 48 computes a RBA score equal to 4 for a valuation of a target property, appraiser assignment unit 50 may be configured to select a staff appraiser included in internal appraiser groups 24 to perform the valuation of the target property. In the case where the valuation is for a mortgage loan origination, appraiser assignment unit 50 may select a staff appraiser from internal appraiser groups 24 that uses an interior valuation tool because the target property is more likely to be empty or inhabited by cooperative sellers. In the case where the valuation is for a mortgage loan default, appraiser assignment unit 50 may select a staff appraiser from internal appraiser groups 24 that uses an exterior valuation tool because the target property is more likely to be inhabited by the defaulting borrowers, who may not want to cooperate in the foreclosure process. If appraiser assignment unit 50 is unable to automatically assign the valuation to an appraiser and a valuation tool having an appropriate accuracy rating, then appraiser assignment unit 50 may notify an administrator or other user of computing device 18 within financial lending system 12 to manually assign the valuation outside of RBA unit 40.

RBA update validation unit 52 may be configured to evaluate any changes or updates made to the models or algorithms used by the other components of RBA unit 40 to compute the RBA scores and assign the property valuations. RBA update validation unit 52 may evaluate an amount of change to the RBA scores under an old model or algorithm compared to a new model or algorithm. For example, RBA update validation unit 52 may determine whether a large change in an RBA score for a valuation of a given target property, e.g., a change from an old score of 3 to a new score of 0 or 1, is due to improvements in the model or algorithm, or is a “bug” in the model or an issue with the data. In some examples, RBA update validation unit 52 may validate updated RBA scores after each modification to the components of RBA unit 40. In some cases, these updates may occur periodically, e.g., on a quarterly or annual basis.

FIG. 3 is a conceptual diagram illustrating one example of a model used to compute a RBA score for a target property in a given time as a weighted sum of a property risk score, a price risk score, and a market risk score. The example model illustrated in FIG. 3 is merely one example of a model to compute a RBA score of a valuation of a target property. The model illustrated in FIG. 3 is intended for purposes of description and should not be considered limiting.

In accordance with the techniques of this disclosure, RBA score 58 may be set to a numerical value that indicates an estimated level of complexity of a valuation of the target property in a given time based on property specific information for the target property and property market information associated with a neighborhood of the target property. In the example of FIG. 3, RBA score 58 comprises a numerical value between 0 and 4 that maps to a total of the weighted sum of property risk score 60, price risk score 62, and market risk score 64 computed for the target property. In this example, a higher value of RBA score 58 indicates a higher level of complexity of the valuation of the target property.

Although not shown in FIG. 3, in some examples, RBA score 58 may be set to a numerical value of 5 in the case where the target property has a high value. For example, RBA score 58 may be set equal to 5 in the case where an estimated current property value of the target property based on home price index is at least $1 million, the original property value of the target property was at least $2 million, or the original property value of the target property was at least $1 million and the estimated current property value of the target property is at least $900,000.

As illustrated in FIG. 3, property risk score 60 has a value between 0 and 4 that indicates a risk level or complexity level of the valuation based on property characteristics of the target property. According to the disclosed techniques, property risk score 60 is computed based at least in part on comparisons of property characteristics of the target property to generated neighborhood property characteristics of the surrounding properties within the same neighborhood as the target property. As described above, the “same neighborhood” of the target property and the surrounding properties may be defined by one of a same zip code, a same zip-plus-two code, or a same zip-plus-four code. The computation of property risk score 60 is described in more detail below with respect to FIGS. 4 and 5.

As illustrated in FIG. 3, price risk score 62 has a value between 0 and 4 that indicates a risk level or complexity level of the valuation based on a property value of the target property. According to the disclosed techniques, price risk score 62 is computed based at least in part on a comparison of a property value of the target property to a generated average assessed value of the surrounding properties within the same neighborhood as the target property. The computation of price risk score 62 is described in more detail below with respect to FIG. 6.

As illustrated in FIG. 3, market risk score 64 has a value between 0 and 2 that indicates a risk level or complexity level of the valuation based on the volatility of the local real estate market. According to the disclosed techniques, market risk score 64 is computed based on market conditions for the local real estate market in the same neighborhood as the target property. The computation of market risk score 64 is described in more detail below with respect to FIG. 7.

In the example of FIG. 3, the model used to calculate RBA score 58 is a weighted sum that places a 30% weighting on property risk score 60, places a 40% weighting on price risk score 62, and places a 30% weighting on market risk score 64. According to the disclosed techniques, in a more stable market, more emphasis may be placed on market conditions. In the illustrated example of FIG. 3, the weight value applied to property risk score 60 and the weight value applied to market risk score 64 are the same. In a more volatile or unstable market, the weighted sum may place more emphasis or weight on property characteristics than market conditions. For example, the weighted sum could place a 53% weighting on a property risk score, a 37% weighting on a price risk score, and only a 10% weighting on a market risk score.

FIG. 4 is a conceptual diagram illustrating one example of a model used to compute the property risk score included in the RBA score model from FIG. 3. The example model illustrated in FIG. 4 is merely one example of a model to compute a property risk score used to compute the RBA score. The model illustrated in FIG. 4 is intended for purposes of description and should not be considered limiting.

In accordance with the techniques of this disclosure, property risk score 60 may be set to a numerical value that indicates an estimated risk level or complexity level of the valuation based on property characteristics of the target property. In the example of FIG. 4, property risk score 60 comprises a numerical value between 0 and 4 that maps to a total of the weighted sum of county risk level 70, property type risk level 72, and property characteristics risk level 74. As discussed above, a valuation complexity of a target property is closely associated with a level of difficulty to select comparable properties for the target property. In this example, a higher value of property risk score 60 indicates a higher level of difficulty in selecting properties with property characteristics similar to the target property.

In the illustrated example of FIG. 4, county risk level 70 has a value between 0 and 4 that indicates the availability of property market information associated with the county in which the target property is located. In this example, a larger county risk level value indicates a smaller amount of available property data. A preliminary factor in selecting comparable properties is actually having a substantial amount of property market data available in a geographic region of the target property from which to select the comparable properties. As an example, a small amount of property market information within a county of the target property typically makes selection of comparable properties relatively difficult.

County risk level 70 provides an indication of data availability at a more detailed geographic level than a state-level data availability determination. County risk level 70 provides a more accurate view of data availability because a majority of the property market information is pulled from county property records. For example, a state may have a relatively large amount of available property data as averaged across its counties, but certain counties within that state may have low levels of available property data. In some examples, an automatic valuation model (AVM) may value every property in a county with a confidence level. If the confidence level is too low, then it may be referred to as a “no hit.” If a given county has a large AVM no hit rate, then that county may have low data availability. In accordance with the disclosed techniques, determining data availability at a county-level, as opposed to a state-level, enables the disclosed model to compute a more accurate property risk score 60 and, in turn, a more accurate RBA score 58 for the target property.

In the illustrated example of FIG. 4, property type risk level 72 has a value of either 0 or 4 that indicates whether the target property is of a certain type or in a certain location that tend to have more complex valuations. For example, property type risk level 72 may have a value equal to 0 if the target property is a single family, a planned unit development (PUD), or a condominium in most markets. On the other hand, property type risk level 72 may have a value equal to 4 if the target property is a multi-family property, or a condominium in certain specified markets, e.g., Phoenix, Cape Coral, Naples, West Palm Beach, Tampa, Fort Lauderdale, Santa Rosa, Las Vegas, Edison, Charleston, S.C., Salt Lake City, Warren, Mich., Houston, Philadelphia, Boston, Lake County, IL, Virginia Beach, or Charlotte.

In the illustrated example of FIG. 4, property characteristics risk level 74 has a value between 0 and 4 that indicates a level of similarity between property characteristics of the target property and median property characteristics of the surrounding properties. For example, a set of median property characteristics may be computed for surrounding properties identified within the same zip-plus-two code as the target property. The set of median property characteristics may include lot size, bedroom count, bathroom count, square footage, and year built. In this example, a larger property characteristics risk level value indicates less similarity between properties. As an example, a target property that has few similarities with its surrounding properties typically makes selection of comparable properties relatively difficult. The computation of property characteristics risk level 74 is described in more detail below with respect to FIG. 5.

In the example of FIG. 4, the model used to calculate property risk score 60 is a weighted sum that places a 60% weighting on county risk level 70, places a 20% weighting on property type risk level 72, and places a 20% weighting on property characteristics risk level 74. According to the disclosed techniques, the determination of county-level data availability, as opposed to state-level data availability, enables more emphasis or weight to be placed on property type and characteristics. In the case where state-level data availability is used, the weighted sum may place more emphasis or weight on a state risk level. For example, the weighted sum could place a 74% weighting on a state risk level, a 10% weighting on a property type risk level, and a 16% weighting on a property characteristics risk level.

FIG. 5 is a conceptual diagram illustrating one example of a model used to compute a property characteristics risk level included in the property risk score model from FIG. 4. The example model illustrated in FIG. 5 is merely one example of a model to compute a property characteristics risk level used to compute the property risk score. The model illustrated in FIG. 5 is intended for purposes of description and should not be considered limiting.

In accordance with the techniques of this disclosure, property characteristics risk level 74 may be set to a numerical value that indicates a level of similarity between property characteristics of the target property and property characteristics of the surrounding properties within the same neighborhood as the target property. In the illustrated example of FIG. 5, property characteristics risk level 74 comprises a numerical value between 0 and 4 that maps to an average of risk levels based on lot size, interior property characteristics, and built year. In this example, a higher value of property characteristics risk level 74 indicates a higher level of difficulty in selecting properties with property characteristics similar to the target property.

As shown in FIG. 5, property characteristics risk level 74 is computed as the average of a lot size risk level, a build year risk level, and an interior risk level, which is a maximum of a bedroom count risk level, a bathroom count risk level, and a square footage risk level. For example, the lot size risk level may comprise a numerical value between 0 and 4 that is selected based on a percentage difference (under or over) of the lot size of the target property compared to the median lot size of the surrounding properties in the same zip-plus-two code. The lot size risk level may not be used in the case where the target property is a condominium. The built year risk level may comprise a numerical value between 0 and 4 that is selected based on a number of decades (i.e., 10 years) between the built year of the target property compared to the median built year of the surrounding properties in the same zip-plus-two code. The bedroom and bathroom count risk levels may each comprise a numerical value between 0 and 4 that is selected based on a number (more or less) of bedrooms or bathrooms included in the target property compared to the median number of bedrooms or bathrooms in the surrounding properties in the same zip-plus-two code. The square footage risk level may comprise a numerical value between 0 and 4 that is selected based on a percentage difference (under or over) of the square footage of the target property compared to the median square footage of the surrounding properties in the same zip-plus-two code.

The median values of the lot size, built year, bedroom and bathroom count, and square footage for the surrounding properties may each be computed as a median value of all the surrounding properties identified within the same zip-plus-two code as the target property. By performing the property characteristic comparisons with surrounding properties at a more detailed geographic level, e.g., zip-plus-two code level as opposed to the MSA level, the county level, or the state level, property characteristics risk level 74 provides a more accurate view of comparable properties. For example, properties of a similar size, age, and room count but that are located on the other side of the city from the target property may not be true comparable properties due to differences in local schools, crime rates, proximity to businesses, and the like. In accordance with the disclosed techniques, determining property characteristics risk level 74 at a zip-plus-two code level enables the disclosed model to compute a more accurate property risk score 60 and, in turn, a more accurate RBA score 58 for the target property.

FIG. 6 is a conceptual diagram illustrating one example of a model used to compute the price risk score included in the RBA score model from FIG. 3. The example model illustrated in FIG. 6 is merely one example of a model to compute a price risk score used to compute the RBA score. The model illustrated in FIG. 6 is intended for purposes of description and should not be considered limiting.

In accordance with the techniques of this disclosure, price risk score 62 may be set to a numerical value that indicates an estimated risk level or complexity level of the valuation based on a property value of the target property. In the example of FIG. 6, price risk score 62 comprises a numerical value between 0 and 4 that maps to a maximum of a current property value risk level or an assessed property value risk level. In this example, a higher value of price risk score 62 indicates a higher level of difficulty in selecting properties having property values that are similar to the property value of the target property.

As shown in FIG. 6, price risk score 62 is computed as the maximum of the current property value risk level, which is based on a comparison of an estimated current property value of the target property to a median sales price in the local real estate market, and the assessed property value risk level, which is based on a comparison of an assessed property value of the target property to a generated average assessed value in the local real estate market. For example, the current property value risk level may comprise a numerical value between 0 and 4 that is selected based on a percentage difference (under or over) of the current property value of the target property compared to the median sales price of the surrounding properties in the same zip code as the target property. The assessed property value risk level may comprise a numerical value between 0 and 4 that is selected based on a percentage difference (under or over) of the assessed property value of the target property compared to the average assessed value of the surrounding properties in the same zip-plus-two code as the target property. By performing the property value comparisons with surrounding properties at a more detailed geographic level, e.g., zip code level or zip-plus-two code level as opposed to the MSA level, the county level, or the state level, price risk score 62 provides a more accurate view of comparable properties.

FIG. 7 is a conceptual diagram illustrating one example of a model used to compute the market risk score included in the RBA score model from FIG. 3. The example model illustrated in FIG. 7 is merely one example of a model to compute a market risk score used to compute the RBA score. The model illustrated in FIG. 7 is intended for purposes of description and should not be considered limiting.

In accordance with the techniques of this disclosure, market risk score 64 may be set to a numerical value that indicates an estimated risk level or complexity level of the valuation based on the volatility of the local real estate market. In the example of FIG. 7, market risk score 64 comprises a numerical value between 0 and 2 that maps to a total of the weighted sum of distressed sales risk level 76 and low sales risk level 78. In this example, a higher value of market risk score 64 indicates more volatile, and therefore less predictable, market conditions in the local real estate market.

As shown in FIG. 7, the distressed sales risk level 76 may comprise a numerical value between 0 and 2 that is selected based on a distressed sales ratio, which is a percentage of distressed sales over a period of time, e.g., 6 months, in the local real estate market within the same zip code as the target property. The distressed sales may include real estate owned (REO) property sales and short sales. In some examples, the distressed sales ratio is not calculated if a total sales count in the given zip code is below a certain number, e.g., 10. The low sales risk level 78 may comprise a numerical value between 0 and 2 that is selected based on a total sales count in the local real estate market within the same zip code as the target property. The total sales count may be a rolling average total sales count over a period of time, e.g., 6 months. In this example, the total sales count is used to represent the risk of low sales levels, as opposed to a change in sales that assesses the risk of high growth due to investors and low growth due to lack of sales.

In the example of FIG. 7, the model used to calculate market risk score 64 is a weighted sum that places a 36% weighting on distressed sales risk level 76 and places a 64% weighting on low sales risk level 78. According to the disclosed techniques, in a more stable market, less emphasis may be placed on distressed sales. In the illustrated example of FIG. 7, the weight value applied to low sales risk level 78 is greater than the weight value applied to distressed sales risk level 76. In a more volatile or unstable market, the weighted sum may place more emphasis or weight on distressed sales than sales growth. For example, the weighted sum could place a 67% weighting on a distressed sales risk level and 33% weighting on a sales growth risk level.

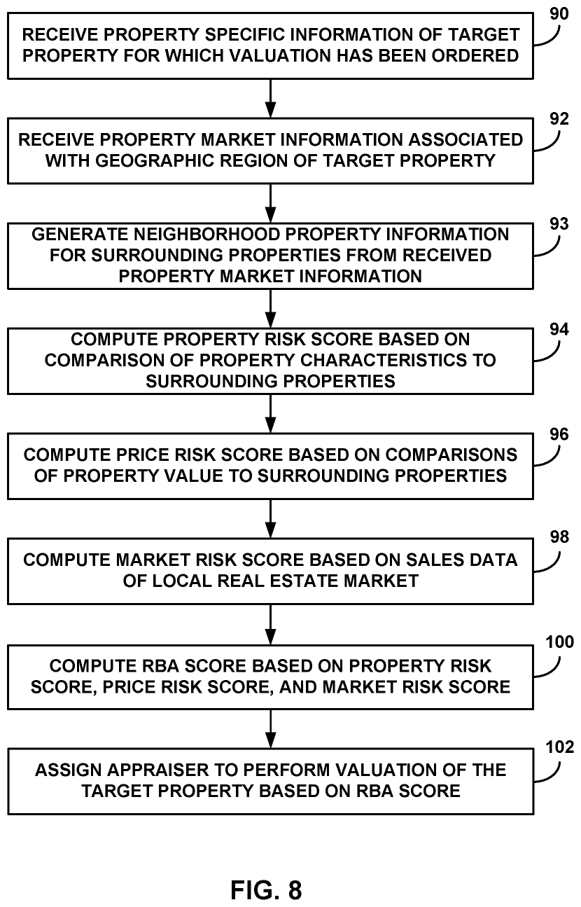

FIG. 8 is a flowchart illustrating an example operation of a computing device configured to compute a RBA score for a target property in a given time, and assign an appraiser to the target property based on the RBA score, in accordance with the techniques of this disclosure. The example operation illustrated in FIG. 8 is described with respect to computing device 18 within financial lending system 12 from FIGS. 1 and 2.

Computing device 18 receives property specific information of a target property for which a valuation has been ordered (90). In some examples, computing device 18 may receive the property specific information for the target property from mortgage records 20 within financial lending system 12. For example, the mortgage record for the target property may comprise a loan origination record for a new mortgage on the target property, or an existing mortgage record for which financial lending system 12 is performing default processing. The property specific information may include property type, lot size, year built, square footage, bedroom and bathroom count, and estimated and assessed property values for the target property. The property specific information received by computing device 18 may be for a given time, e.g., a given month, a given quarter, or a given year, because the property specific information for the target property may change over time due to modifications to the property and market fluctuations.

Computing device 18 also receives property market information associated with a geographic region in which the target property is located (92). Computing device 18 may receive the property market information from third-party server 14, which receives at least a portion of the property market information from county property records 22. The property market information may include property characteristics of properties within the geographic region, sales prices and assessed values in the local real estate market, distressed sales in the local real estate market, and a total sales count in the local real estate market.

In accordance with the disclosed techniques, computing device 18 generates neighborhood property information for surrounding properties within a same neighborhood as the target property from the received property market information (93). For example, the received property market information may comprise property-level information for each property with the geographic region, e.g., the county, of the target property. The generated neighborhood property information for the surrounding properties is defined at a neighborhood-level (e.g., at one of a zip code level, a zip-plus-two code level, or a zip-plus-four code level). In one example, upon receiving the property-level property market information, computing device 18 may identify the surrounding properties that are included in a same zip-plus-two code as the target property, compute, from the property market information, a set of median property characteristics of the surrounding properties within the same zip-plus-two code as the target property, and compute, from the property market information, an average assessed value of the surrounding properties within the same zip-plus-two code as the target property.

In addition, computing device 18 may determine the availability of the property market information at a county-level as opposed to a state-level. The property market information received by computing device 18 may be for a given time, e.g., a given month, a given quarter, or a given year, because the property market information changes over time based on sales in the market and market fluctuations.

Computing device 18 then computes a RBA score for the target property based on comparisons of the property specific information of the target property to the property market information for surrounding properties within the same neighborhood as the target property. As described above, the “same neighborhood” of the target property and the surrounding properties may be defined by one of a same zip code, a same zip-plus-two code, or a same zip-plus-four code. The techniques of this disclosure include a model or algorithm used to compute the RBA score based on a property risk score, a price risk score, and a market risk score.

According to the disclosed model, computing device 18 computes the property risk score based at least in part on comparisons of property characteristics of the target property to a set of median property characteristics of the surrounding properties (94). In one example, for the property risk score computation, the surrounding properties may be within the same zip-plus-two code as the target property. Performing the comparisons between the target property and surrounding properties at a more detailed geographic level, i.e., within the same zip-plus-two code as opposed to a same MSA, county, or state, enables the disclosed model to compute a more accurate RBA score for the target property.

As one example, computing device 18 computes the property risk score as a weighted sum of a county risk level, a property type risk level, and a property characteristics risk level. Computing device 18 may determine the county risk level based on the availability of the property market information associated with the county in which the target property is located. Determining data availability at a county-level, as opposed to a state-level, enables the disclosed model to compute a more accurate RBA score for the target property. Computing device 18 may determine a property type risk level based on a type (e.g., single family, condominium, or multifamily) and location of the target property. Computing device 18 may compute the property characteristics risk level, as discussed above, based on the comparison of the property characteristics of the target property to the set of median property characteristics of the surrounding properties within the same zip-plus-two code as the target property.

Computing device 18 computes the price risk score based on a comparison of a property value of the target property to an average assessed value of the surrounding properties (96). As one example, computing device 18 computes a first risk level based on a comparison of an estimated current property value of the target property to a median sales price of the surrounding properties within the same zip code as the target property, and computes a second risk level based on a comparison of an assessed property value of the target property to the average assessed value of the surrounding properties within the same zip-plus-two code as the target property. Computing device 18 then selects a maximum one of the first risk level or the second risk level as the price risk score.

Computing device 18 computes the market risk score based on sales data of the local real estate market (98). As one example, computing device 18 computes the market risk score as a weighted sum of the distressed sales risk level and the low sales risk level. Computing device 18 may determine the distressed sales risk level based on a distressed sales ratio for the local real estate market within the same zip code as the target property. Computing device 18 may determine the low sales risk level based on a total sale count for the local real estate market within the same zip code as the target property. According to the disclosed techniques, less emphasis may be placed on distressed sales in the case of a stable market. In this case, the weight value applied to the low sales risk level may be greater than a weight value applied to the distressed sales risk level.

Computing device 18 then computes the RBA score for the valuation of the target property as a weighted sum of the property risk score, the price risk score, and the market risk score (100). According to the disclosed techniques, more emphasis may be placed on market conditions in the case of a stable market. In this case, the weight value applied to the property risk score and the weight value applied to the market risk score are substantially similar.

Based on the RBA score, computing device 18 assigns an appraiser to perform the valuation of the target property (102). In some cases, financial lending system 12 may categorize appraisers, and valuation tools used by the appraisers, based on their accuracy. For example, financial lending system 12 may categorize internal appraiser groups 24 as being more accurate than any of external appraiser groups 26. According to the disclosed model, computing device 18 is configured to assign valuations of target properties having high RBA scores, i.e., high risk or high complexity valuations, to appraisers and valuation tools identified as being highly accurate. Similarly, computing device 18 may be configured to assign valuations of target properties having low RBA scores to appraisers and valuation tools identified as being less accurate.

The disclosed techniques may be used to select appraisers for residential property valuations. In other examples, the disclosed techniques may be used to select appraisers for commercial property valuations or other types of property valuations that use a sales comparison method. The disclosed techniques may be used to select appraisers for either mortgage loan default or mortgage loan origination. For example, computing device 18 may select one of internal appraiser groups 24 and external appraiser groups 26 to perform an exterior valuation of a target property for a property loan default based on the RBA score for the target property. As another example, computing device 18 may select one of internal appraiser groups 24 and external appraiser groups 26 to perform an interior valuation of a target property for a property loan origination based on the RBA score for the target property.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over a computer-readable medium as one or more instructions or code, and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), or other equivalent integrated or discrete logic circuitry, as well as any combination of such components. Accordingly, the term “processor,” as used herein may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless communication device or wireless handset, a microprocessor, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples have been described. These and other examples are within the scope of the following claims.

1: A method comprising:
creating, by a computing device, a model configured to compute a risk based assignment (RBA) score as a first weighted sum of a property risk score, a price risk score, and a market risk score, wherein creating the model comprises assigning weight values to the property risk score, the price risk score, and the market risk score based on a local real estate market, and wherein, based on a first type of local real estate market, the model assigns a first weight value applied to the property risk score and a second weight value applied to the market risk score that are equal and assigns a third weight value applied to the price risk score that is greater than each of the first weight value or the second weight value;
receiving, by the computing device, property specific information of a target property for which a valuation has been ordered;
receiving, by the computing device, property market information associated with a geographic region in which the target property is located;
analyzing, by the computing device, the property market information to determine availability of the property market information at a county-level granularity for the target property;
analyzing, by the computing device, the property market information to determine neighborhood property information for surrounding properties at a neighborhood-level granularity for the target property;
computing, by the computing device, the RBA score for the target property based on the availability of the property market information at the county-level granularity for the target property and comparisons of the property specific information of the target property to the neighborhood property information for the surrounding properties at the neighborhood-level granularity for the target property, wherein the RBA score indicates a level of complexity of the valuation of the target property;
wherein computing the RBA score comprises applying the property risk score, the price risk score, and the market risk score as input to the model, and computing the RBA score as the first weighted sum of the property risk score, the price risk score, and the market risk score as output from the model;
categorizing, by the computing device, each appraiser of a plurality of appraisers and each tool of a plurality of valuation tools based on associated accuracy ratings in performing property valuations;
selecting, by the computing device and based on the RBA score, a first appraiser from the plurality of appraisers to perform the valuation of the target property, the first appraiser having an associated accuracy rating necessary for the level of complexity of the valuation indicated by the RBA score;
selecting, by the computing device and based on the RBA score, a first valuation tool from the plurality of valuation tools having an associated accuracy rating necessary for the level of complexity of the valuation indicated by the RBA score; and
sending, by the computing device and to one or more computing devices of an appraiser group of the first appraiser, an assignment for the first appraiser to perform the valuation of the target property using the first valuation tool.

2: The method of claim 1, wherein analyzing the property market information to determine the neighborhood property information for the surrounding properties at the neighborhood-level granularity for the target property comprises determining the neighborhood property information for the surrounding properties at one of a zip code granularity for the target property, a zip-plus-two code granularity for the target property, or a zip-plus-four code granularity for the target property.

3. (canceled)

4. (canceled)

5: The method of claim 1, wherein analyzing the property market information to determine the neighborhood property information for the surrounding properties at the neighborhood-level granularity for the target property comprises:
identifying the surrounding properties that are included in a same zip-plus-two code as the target property;
computing, from the property market information, a set of median property characteristics of the surrounding properties within the same zip-plus-two code as the target property; and
computing, from the property market information, an average assessed value of the surrounding properties within the same zip-plus-two code as the target property.

6: The method of claim 1, wherein computing the RBA score comprises:
computing the property risk score based on the availability of the property market information at the county-level granularity for the target property and a comparison of property characteristics of the target property to a set of median property characteristics generated for the surrounding properties at a zip-plus-two code granularity for the target property;
computing the price risk score based on a comparison of a property value of the target property to an average assessed value generated for the surrounding properties at the zip-plus-two code granularity for the target property;
computing the market risk score based on sales data for the local real estate market determined at a zip code granularity for the target property; and
computing the RBA score as the weighted sum of the property risk score, the price risk score, and the market risk score.

7: The method of claim 6, wherein computing the property risk score comprises:
determining a county risk level based on the availability of the property market information at the county-level granularity for the target property;
determining a property type risk level based on a type and location of the target property;
computing a property characteristics risk level based on the comparison of the property characteristics of the target property to the set of median property characteristics generated for the surrounding properties at the zip-plus-two code granularity for the target property; and
computing the property risk score as a weighted sum of the county risk level, the property risk level, and the property characteristics risk level.

8: The method of claim 6, wherein computing the price risk score comprises:
computing a first risk level based on a comparison of an estimated current property value of the target property to a median sales price determined for the surrounding properties at the zip code granularity for the target property;
computing a second risk level based on a comparison of an assessed property value of the target property to the average assessed value generated for the surrounding properties at the zip-plus-two code granularity for the target property; and
selecting a maximum one of the first risk level or the second risk level as the price risk score.

9: The method of claim 6, wherein computing the market risk score comprises:
determining a distressed sales risk level based on a distressed sales ratio for the local real estate market at the zip code granularity for the target property;
determining a low sales risk level based on a total sale count for the local real estate market at the zip code granularity for the target property; and
computing the market risk score as a weighted sum of the distressed sales risk level and the low sales risk level, wherein a weight value applied to the low sales risk level is greater than a weight value applied to the distressed sales risk level.

10: The method of claim 1, wherein computing the RBA score comprises computing the RBA score for the target property in a given time, wherein the given time comprises one of a given month, a given quarter, or a given year.

11: The method of claim 1, wherein the valuation of the target property comprises an exterior valuation of the target property for a property loan default.

12: The method of claim 1, wherein the valuation of the target property comprises at least one of an interior valuation or an exterior valuation of the target property for a property loan origination.

13: A computing device comprising:
one or more storage units configured to store one or more of property specific information or property market information; and
one or more processors in communication with the one or more storage units and configured to:
create a model configured to compute a risk based assignment (RBA) score as a first weighted sum of a property risk score, a price risk score, and a market risk score, wherein creating the model comprises assigning weight values to the property risk score, the price risk score, and the market risk score based on a local real estate market, and wherein, based on a first type of local real estate market, the model assigns a first weight value applied to the property risk score and a second weight value applied to the market risk score that are equal and assigns a third weight value applied to the price risk score that is greater than each of the first weight value or the second weight value;
receive property specific information of a target property for which a valuation has been ordered;
receive property market information associated with a geographic region in which the target property is located;
analyze the property market information to determine availability of the property market information at a county-level granularity for the target property;
analyze the property market information to determine neighborhood property information for surrounding properties at a neighborhood-level granularity for the target property;
compute the RBA score for the target property based on the availability of the property market information at the county-level granularity for the target property and comparisons of the property specific information of the target property to the neighborhood property information for the surrounding properties at the neighborhood-level granularity for the target property, wherein the RBA score indicates a level of complexity of the valuation of the target property;
wherein to compute the RBA score, the one or more processors are configured to apply the property risk score, the price risk score, and the market risk score as input to the model, and compute the RBA score as the first weighted sum of the property risk score, the price risk score, and the market risk score as output from the model;
categorize each appraiser of a plurality of appraisers and each tool of a plurality of valuation tools based on associated accuracy ratings in performing property valuations;
select, based on the RBA score, a first appraiser from the plurality of appraisers to perform the valuation of the target property, the first appraiser having an associated accuracy rating necessary for the level of complexity of the valuation indicated by the RBA score;
select, based on the RBA score, a first valuation tool from the plurality of valuation tools having an associated accuracy rating necessary for the level of complexity of the valuation indicated by the RBA score; and
send, to one or more computing device of an appraiser group of the first appraiser, an assignment for the first appraiser to perform the valuation of the target property using the first valuation tool.

14: The computing device of claim 13, wherein, to analyze the property market information to determine the neighborhood property information for the surrounding properties at the neighborhood-level granularity for the target property, the one or more processors are configured to determining the neighborhood property information for the surrounding properties at one of a zip code granularity for the target property, a zip-plus-two code granularity for the target property, or a zip-plus-four code granularity for the target property.

15. (canceled)

16. (canceled)

17: The computing device of claim 13, wherein, to analyze the property market information to determine the neighborhood property information for the surrounding properties at the neighborhood-level granularity for the target property, the one or more processors are configured to:
identify the surrounding properties that are included in a same zip-plus-two code as the target property;
compute, from the property market information, a set of median property characteristics of the surrounding properties within the same zip-plus-two code as the target property; and
compute, from the property market information, an average assessed value of the surrounding properties within the same zip-plus-two code as the target property.

18: The computing device of claim 13, wherein, to compute the RBA score, the one or more processors are configured to:
compute the property risk score based on the availability of the property market information at the county-level granularity for the target property and a comparison of property characteristics of the target property to a set of median property characteristics generated for the surrounding properties at a zip-plus-two code granularity for the target property;
compute the price risk score based on a comparison of a property value of the target property to an average assessed value generated for the surrounding properties at a zip-plus-two code granularity for the target property;
compute the market risk score based on sales data for the local real estate market determined at a zip code granularity for the target property; and
compute the RBA score as the weighted sum of the property risk score, the price risk score, and the market risk score.

19: The computing device of claim 18, wherein, to compute the property risk score, the one or more processors are configured to:
determine a county risk level based on the availability of the property market information at the county-level granularity for the target property;
determine a property type risk level based on a type and location of the target property;
compute a property characteristics risk level based on the comparison of the property characteristics of the target property to the set of median property characteristics generated for the surrounding properties at the zip-plus-two code granularity for the target property; and
compute the property risk score as a weighted sum of the county risk level, the property risk level, and the property characteristics risk level.

20: The computing device of claim 18, wherein, to compute the price risk score, the one or more processors are configured to:
compute a first risk level based on a comparison of an estimated current property value of the target property to a median sales price determined for the surrounding properties at the zip code granularity for the target property;
compute a second risk level based on a comparison of an assessed property value of the target property to the average assessed value generated for the surrounding properties at the zip-plus-two code granularity for the target property; and
select a maximum one of the first risk level or the second risk level as the price risk score.

21: The computing device of claim 18, wherein, to compute the market risk score, the one or more processors are configured to:
determine a distressed sales risk level based on a distressed sales ratio for the local real estate market at the zip code granularity for the target property;
determine a low sales risk level based on a total sale count for the local real estate market at the zip code granularity for the target property; and
compute the market risk score as a weighted sum of the distressed sales risk level and the low sales risk level, wherein a weight value applied to the low sales risk level is greater than a weight value applied to the distressed sales risk level.

22: A non-transitory computer-readable medium comprising instructions that when executed cause one or more processors to:
create a model configured to compute a risk based assignment (RBA) score as a first weighted sum of a property risk score, a price risk score, and a market risk score, wherein creating the model comprises assigning weight values to the property risk score, the price risk score, and the market risk score based on a local real estate market, and wherein, based on a first type of local real estate market, the model assigns a first weight value applied to the property risk score and a second weight value applied to the market risk score that are equal and assigns a third weight value applied to the price risk score that is greater than each of the first weight value or the second weight value;
receive property specific information of a target property for which a valuation has been ordered;
receive property market information associated with a geographic region in which the target property is located;
analyze the property market information to determine availability of the property market information at a county-level granularity for the target property;
analyze the property market information to determine neighborhood property information for surrounding properties at a neighborhood-level granularity for the target property;
compute the RBA score for the target property based on the availability of the property market information at the county-level granularity for the target property and comparisons of the property specific information of the target property to the neighborhood property information for the surrounding properties at the neighborhood-level granularity for the target property, wherein the RBA score indicates a level of complexity of the valuation of the target property;
wherein to compute the RBA score, the instructions cause the one or more processors to apply the property risk score, the price risk score, and the market risk score as input to the model, and compute the RBA score as the first weighted sum of the property risk score, the price risk score, and the market risk score as output from the model;
categorize each appraiser of a plurality of appraisers and each tool of a plurality of valuation tools based on associated accuracy ratings in performing property valuations;
select, based on the RBA score, a first appraiser from the plurality of appraisers to perform the valuation of the target property, the first appraiser having an associated accuracy rating necessary for the level of complexity of the valuation indicated by the RBA score;
select, based on the RBA score, a first valuation tool from the plurality of valuation tools having an associated accuracy rating necessary for the level of complexity of the valuation indicated by the RBA score; and
send, to one or more computing devices of an appraiser group of the first appraiser, an assignment for the first appraiser to perform the valuation of the target property using the first valuation tool.

23: The method of claim 1, further comprising periodically updating, by the computing device, the model as a second weighted sum of the property risk score, the price risk score, and the market risk score,
wherein updating the model comprises updating the weight values assigned to the property risk score, the price risk score, and the market risk score based on changes to the local real estate market, and
wherein, based on a second type of local real estate market different from the first type of local real estate market, the updated model assigns a fourth weight value applied to the property risk score, assigns a fifth weight value applied to the price risk score that is less than the fourth weight value, and assigns a sixth weight value applied to the market risk score that is less than each of the fourth weight value or the fifth weight value.

24: The method of claim 23, further comprising, after updating the model:
computing, by the computing device, an updated RBA score for the target property, wherein computing the updated RBA score comprises applying the property risk score, the price risk score, and the market risk score as input to the updated model, and computing the RBA score as the second weighted sum of the property risk score, the price risk score, and the market risk score as output from the updated model; and
validating, by the computing device, the updated RBA score for the target property, wherein validating the updated RBA score comprises determining that an amount of change between the RBA score computed according to the model as the first weighted sum and the updated RBA score computed according to the updated model as the second weighted sum is due to the updated weight values being more accurate based on the changes to the local real estate market and not due to an error in the updated model.

25: The computing device of claim 13, wherein the one or more processors are configured to periodically update the model as a second weighted sum of the property risk score, the price risk score, and the market risk score,
wherein, to update the model, the one or more processors are configured to update the weight values assigned to the property risk score, the price risk score, and the market risk score based on changes to the local real estate market, and
wherein, based on a second type of local real estate market different from the first type of local real estate market, the updated model assigns a fourth weight value applied to the property risk score, assigns a fifth weight value applied to the price risk score that is less than the fourth weight value, and assigns a sixth weight value applied to the market risk score that is less than each of the fourth weight value or the fifth weight value.

26: The computing device of claim 25, wherein the one or more processors are configured to, after updating the model:
compute an updated RBA score for the target property, wherein to compute the RBA score, the one or more processors are configured to apply the property risk score, the price risk score, and the market risk score as input to the updated model, and compute the RBA score as the second weighted sum of the property risk score, the price risk score, and the market risk score as output from the updated model; and
validate the updated RBA score for the target property, wherein to validate the updated RBA score, the one or more processors are configured to determine that an amount of change between the RBA score computed according to the model as the first weighted sum and the updated RBA score computed according to the updated model as the second weighted sum is due to the updated weight values being more accurate based on changes to the local real estate market and not due to an error in the updated model.
